(19) United States
(12) Patent Application Publication
(10) Pub. No.: US 2015/0297952 A1
(43) Pub. Date: Oct. 22, 2015

(54) SCUBA MASK STRUCTURE AND MANUFACTURING PROCESS THEREOF

(71) Applicant: Hsin-Yu Lo, New Taipei City (TW)

(72) Inventor: Hsin-Yu Lo, New Taipei City (TW)

(21) Appl. No.: 14/258,036

(22) Filed: Apr. 22, 2014

(51) Int. Cl. A63B 33/00; B29D 99/00; B29C 45/00

(52) U.S. Cl. CPC A63B 33/002; B29C 45/0003; B29D 99/0071; B29L 2031/4835

(57) ABSTRACT

Disclosed are a scuba mask structure and a manufacturing process thereof. The structure includes an integrally-formed support section including at least one window section forming in one side thereof and having an edge that is distant from the window section and is coupled to a flexible attaching section that is also integrally formed in a two-side covering manner. In the manufacture, a mold is used to first make the flexible attaching section, which is then placed in another mold for processing, or alternatively, a multiple-material injection molding machine is applied to carry out automatic molding without removing the flexible attaching section, in which before the processing, a window section is placed in the mold to be processed simultaneously. Thereafter, a support section is formed in such a way that one side of the support section completely covers the window section and an opposite side coupled to the flexible attaching section.

### (a) TECHNICAL FIELD OF THE INVENTION

The present invention generally relates to scuba masks, and more particularly to a scuba mask structure and manufacturing process thereof that requires no assembling and has a good yield rate, a low cost, and a simple structure.

### (b) DESCRIPTION OF THE PRIOR ART

In doing activities under water, to protect human eyes from being irritated by liquids, such as seawater and to allow people to clearly observe the surrounding environment in water, swimming goggles are available. The conventional products can be generally classified into two categories, i.e. swimming goggles for swimming and scuba masks for scuba diving. Taking the scuba mask as an example, the conventional ways of manufacturing scuba masks are generally complicated processes, including the making of components by using molds and additional assembling of the components. For example, when a skirt portion of a scuba mask that is put in contact with human skin is to combine with a flange portion for mounting a lens, a process of one side resin flow is applied to combine the flange and skirt portions together to form a base. A seat is then coupled to the lens and frame feature. Finally, an outer fixing frame is mounted to securely hold the lens. This completes the assembling process of the scuba masks.

However, there are problems existing in the conventional way of manufacturing scuba masks.

The number of parts is great and the parts must be assembled. This lead to undesired influences on the quality, speed, cost, and throughput of the manufacture of scuba masks and poses a great influence on the competition power of the product in the market.

It is the challenge of the industry and manufacturers to develop a solution to overcome the above-discussed problems.

### SUMMARY OF THE INVENTION

The present invention aims to provide a scuba mask structure and manufacturing process thereof that requires no assembling and has a good yield rate, a low cost, and a simple structure.

The primary object of the present invention is that a flexible attaching section is provided for coupling with an edge of a support section in a simultaneously two side covering manner so as to achieve an effect of excellent securing with a reduced coupling area, making it visually free of joint seam.

Another object of the present invention is that an integrally-formed covering arrangement of a window section is provided to achieve the advantages of simple structure, being free of assembling, low cost, and good yield rate.

To achieve the above objects, the scuba mask structure comprises at least one integrally-formed support section and a flexible attaching section that is coupled to an edge of the support section that is distant from the window section in a simultaneously two side covering manner, wherein the support section is first formed, in one side thereof, at least one window section and as such, during the process, a mold is used to form the flexible attaching section and then, the flexible attaching section is placed in another mold, or alternatively, a multiple-material injection molding machine is used to carry out automatic molding without removing the flexible attaching section with a window section being placed in the mold to be processed simultaneously. After removal from the mold, a support section that has one side forming and covering a window section and an opposite side coupled to a flexible attaching section and the flexible attaching section is coupled to the edge of the support section in a simultaneously two side covering manner.

With the above-described techniques, the problems of the manufacture of the conventional scuba mask that the number of parts is great so that additional processes of assembling are needed and thus the quality, speed, cost, and throughput of production are greatly affected and the market competition power is influenced can be overcome.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is an enlarged view of a portion of the preferred embodiment of the present invention.

FIG. 3 is a flow chart illustrating a manufacturing process according to an embodiment of the present invention.

FIG. 4 is a flow chart illustrating a manufacturing process according another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

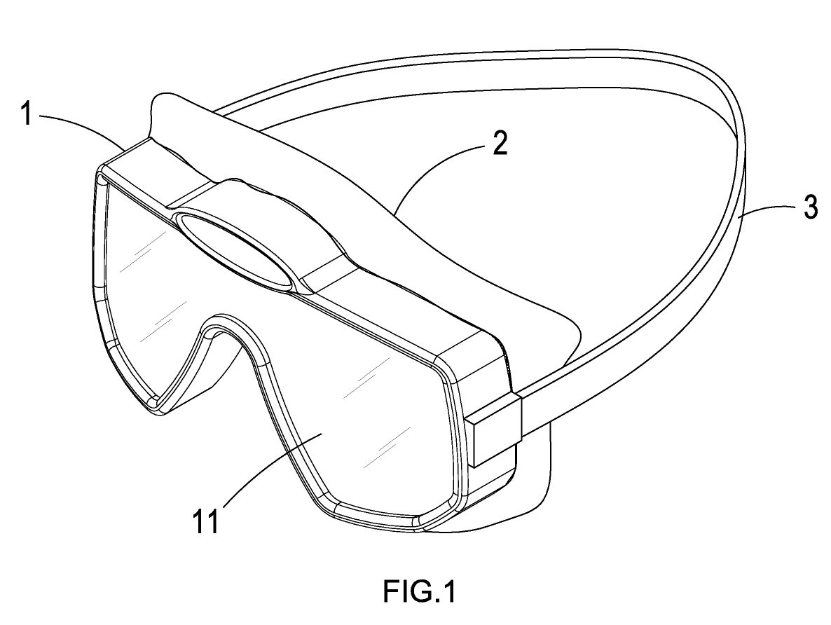

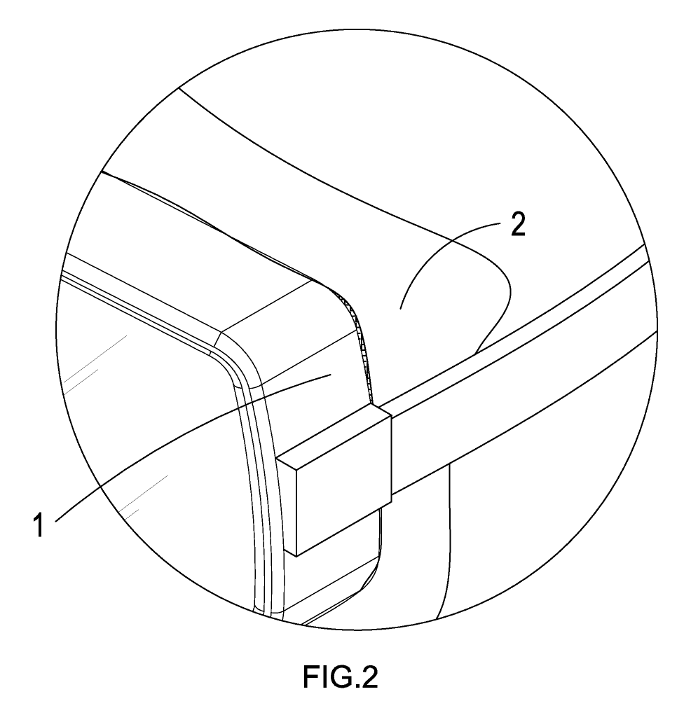

Referring to FIGS. 1 and 2, which are respectively a perspective view of a preferred embodiment of the present invention and an enlarged view of a portion of the preferred embodiment of the present invention, these drawings clearly show that the present invention comprises:

at least one integrally-formed support section 1, wherein the support section 1 comprises at least one window section 11 formed in one side thereof for a light-transmitting lens, the support section 1 being made of a rigid material;

at least one flexible attaching section 2, which is coupled to an edge of the support section 1 that is distant from the window section 11 in a two-side covering manner, the flexible attaching section 2 being integrally formed and made of a flexible material; and

a head strap 3, which is coupled to the support section 1.

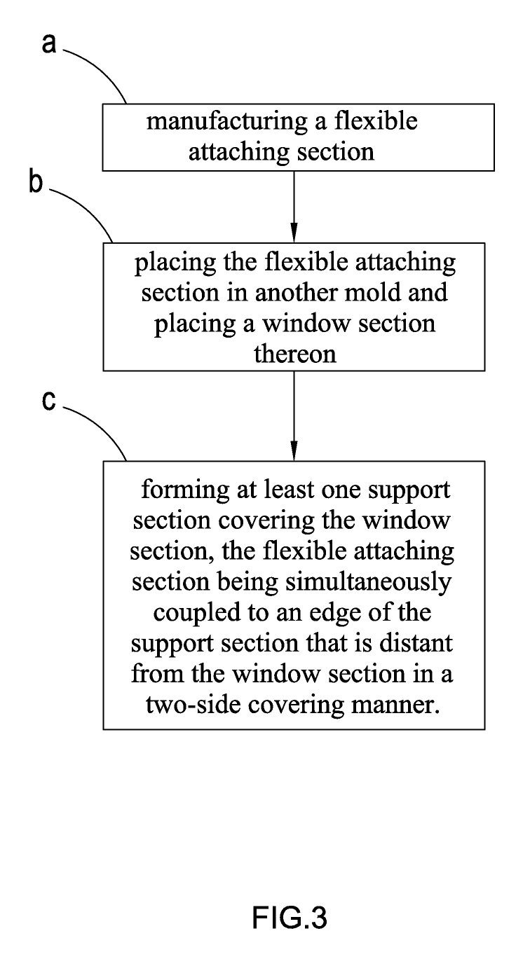

Referring also to FIG. 3, which is a flow chart illustrating a manufacturing process according to an embodiment of the present invention, the drawing clearly shows that the process of manufacturing scuba masks according to the present in invention comprises, in sequence, the following steps: (a) manufacturing a flexible attaching section; (b) having the flexible attaching section and a window section coupled to each other in the same mold; and (c) forming scuba masks.

These steps will be described in more details in the following:

(a) providing a mold to make, in an integrally-formed manner, at least one flexible attaching section;

(b) placing the flexible attaching section in another mold and placing a window section thereon; and

(c) forming at least one support section covering the window section, the flexible attaching section being simultaneously coupled to an edge of the support section that is distant from the window section in a two-side covering manner.

As such, the scuba mask according to the present invention is produced and the process is simple.

Further details of the above-described steps will be given as follows:

(a) providing a mold to make, in an integrally-formed manner, at least one flexible attaching section, and removing films from surfaces of the flexible attaching section for performance of subsequent processing;

(b) placing the flexible attaching section in another mold and placing a window section thereon, and closing the mold for performance of the subsequent processing;

(c) forming at least one support section covering the window section, the flexible attaching section being simultaneously coupled to an edge of the support section that is distant from the window section in a two-side covering manner; and

(d) having a head strap and the support section coupled to each other to complete the swimming goggles.

As described above, the window section comprises a light-transmitting lens.

As described above, the support section is made of a rigid material and the flexible attaching section is made of a flexible material.

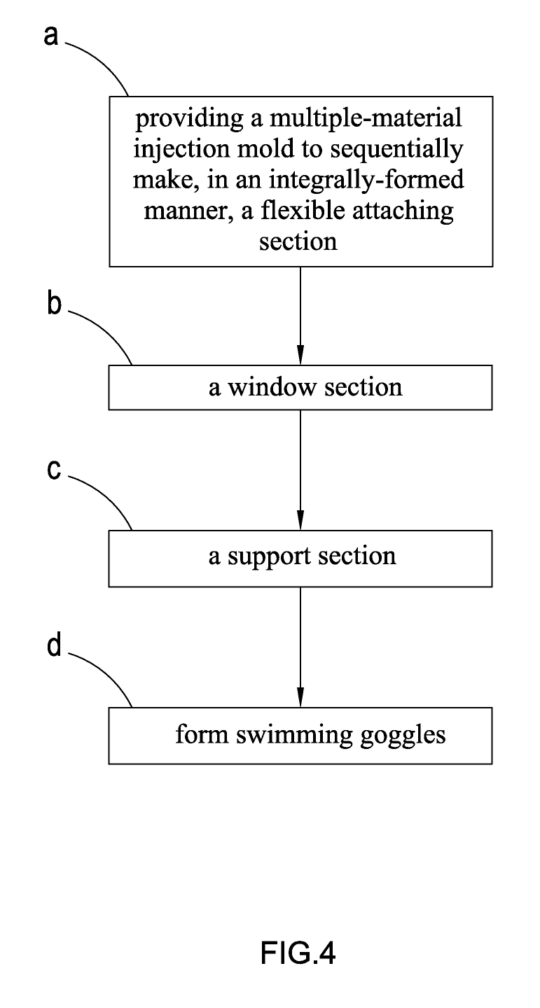

Referring to FIG. 4, which is a flow chart illustrating a manufacturing process according another embodiment of the present invention, the drawing clearly shows that a manufacturing process of the present invention comprises: (a) providing a multiple-material injection mold to sequentially make, in an integrally-formed manner, a flexible attaching section, (b) a window section, and (c) a support section, so as to (d) form a scuba mask. Further details are as follows:

(a) providing a multiple-material injection mold to make, in an integrally-formed manner, at least one flexible attaching section;

(b) forming, during the injection process, a window section on the flexible attaching section;

(c) forming, during the injection process, at least one support section on the window section in such a way to have the support section covering the window section and the flexible attaching section is coupled to an edge of the support section that is distant from the window section in a two-side covering manner.

As such, with the above-described manufacturing process, the flexible attaching section, the window section, and the support section can be automatically formed in a single process of injection molding in a multiple-material injection molding machine to complete the formation of the scuba mask according to the present invention. The difference of the instant embodiment from the previous embodiment is that automatic formation can be carried out with a multiple-material injection-molding machine so that straightforward formation can be done without a step of removal of the flexible attaching section.

Thus, with the above manufacturing processes, the key features that the present invention adopts to improve the prior art are as follows:

Allowing the flexible attaching section 2 to couple to an edge of the support section 1 in a manner of simultaneous covering of two sides so as to achieve an excellent effect of securing with a reduced coupling area, making it visually free of joint seam and providing advantages of simple structure, being free of assembling, low cost, and good yield rate.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A scuba mask structure, comprising:
at least one integrally-formed support section, wherein the support section comprises at least one window section formed in one side thereof; and
at least one flexible attaching section, which is coupled to an edge of the support section that is distant from the window section in a two-side covering manner, the flexible attaching section being integrally formed.

2. The scuba mask structure according to claim 1, wherein the window section comprises a light-transmitting lens.

3. The scuba mask structure according to claim 1, wherein the support section is made of a rigid material and the flexible attaching section is made of a flexible material.

4. The scuba mask structure according to claim 1 further comprising a head strap coupled to the support section.

5. A scuba mask manufacturing process, comprising the following steps:
(a) providing a mold to make, in an integrally-formed manner, at least one flexible attaching section;
(b) placing the flexible attaching section in another mold and placing a window section thereon; and
(c) forming at least one support section covering the window section, the flexible attaching section being simultaneously coupled to an edge of the support section that is distant from the window section in a two-side covering manner.

6. The scuba mask manufacturing process according to claim 5, wherein step (a) further comprises a step of removing films from surfaces of the flexible attaching section.

7. The scuba mask manufacturing process according to claim 5, wherein after the window section is placed on the flexible attaching section in step (b), the mold is closed for performance of subsequent processing.

8. The scuba mask manufacturing process according to claim 5 further comprising step (d) to have a head strap and the support section coupled to each other to complete the scuba mask.

9. The scuba mask manufacturing process according to claim 5, wherein the window section comprises a light-transmitting lens and the support section is made of a rigid material and the flexible attaching section is made of a flexible material.

10. A scuba mask manufacturing process, comprising the following steps:
(a) providing a multiple-material injection mold to make, in an integrally-formed manner, at least one flexible attaching section;
(b) forming, during the injection process, a window section on the flexible attaching section;
(c) forming, during the injection process, at least one support section on the window section in such a way to have the support section covering the window section and the flexible attaching section is coupled to an edge of the support section that is distant from the window section in a two-side covering manner.
